(19) United States
(12) Patent Application Publication
(10) Pub. No.: US 2024/0272934 A1
(43) Pub. Date: Aug. 15, 2024

(54) SYSTEMS AND METHODS FOR AUTOMATING SOFTWARE MIGRATIONS

(71) Applicant: SAP SE, Walldorf (DE)

(72) Inventors: Ashok Rajashekar, Bangalore (IN); Ramya Nandakumaran, Bangalore (IN); Sandhya Mokshagundam, Bangalore (IN); Priyanka Hosur, Bangalore (IN)

(21) Appl. No.: 18/169,410

(22) Filed: Feb. 15, 2023

(51) Int. Cl. G06F 9/48

(52) U.S. Cl. CPC G06F 9/4856

(57) ABSTRACT

Embodiments of the present disclosure include techniques for automating the migration of software constructs between sources and targets. In one embodiment, software stacks are migrated between versions or system using an automated bot. The bot accesses a front end and backend of a system and loads software stacks that reside on the front and back ends. The bot may access a table comprising a batch of stories to be migrated. The bot is configured to invoke actions on the front end to automatically perform the migration process. Results of the migration are stored in the table, including whether or not the migration was successful and information about the results.

### BACKGROUND

The present disclosure relates generally to software systems, and in particular, to systems and methods for automating software migrations.

Computers require code (software) to operate. However, for computers to operation effectively, software is often required to migrate from various sources to targets. For example, one challenge today for designers or users of enterprise software systems (e.g., SAP® Analytics Cloud Story (SAC)) is to manage a migration process with manual workflows. There is no simple and faster way to automate migration processes.

Moreover, business intelligence (BI) designers and users may be required to convert software stacks, such as an SAP Analytics cloud story, from older version to newer versions. Additionally, it may be necessary to import and export content from test tenant to production tenant. This can be a difficult and tedious job for all the users to perform in an application having a large number of dashboards, for example. All these business processes have to manually check and migrate the contents to other systems.

There is currently no simple and intuitive way for users to migrate the entire enterprise system content with a large number of dashboards automatically. More generally, automating migration processes in enterprise software applications would be very beneficial and render the computer a more effective tool.

### BRIEF DESCRIPTION OF THE DRAWINGS

FIG. 1 illustrates a computer system for migrating software according to an embodiment.

FIG. 2 illustrates a method of migrating software according to an embodiment.

FIG. 3A is an example software system and bot for migrating software according to an embodiment.

FIG. 3B is an example error message created when migrating software according to an embodiment.

FIG. 4 is an example process for migrating software according to an embodiment.

FIG. 5 is another example process for migrating software according to an embodiment.

FIG. 6 is an example computer hardware system with an improved software migration system according to an embodiment.

### DETAILED DESCRIPTION

Described herein are techniques for automating software migrations. In the following description, for purposes of explanation, numerous examples and specific details are set forth in order to provide a thorough understanding of some embodiments. Various embodiments as defined by the claims may include some or all of the features in these examples alone or in combination with other features described below and may further include modifications and equivalents of the features and concepts described herein.

Features and advantages of the present disclosure include an automated software bot (“BOT”) which automates software processes in an enterprise software system, such as an enterprise analytics cloud software system, for example. A bot is an autonomous program that interacts with systems or users. In example embodiments, a bot may be used to migrate “stories” between application versions. Stories may include software stacks comprising data and metadata software constructs. Stories may be used to present data about various topics in a variety of ways specified by a user to make information about the topic readily and intuitively available to one or more users. For example, a story may comprise data structures, data models, data objects, and rendering libraries. Stories may comprise visualizations of data created from one or more data sources with custom filters applied. In some embodiments, bots may be used to migrate enterprise software content between systems, such as importing or exporting software stacks as described herein.

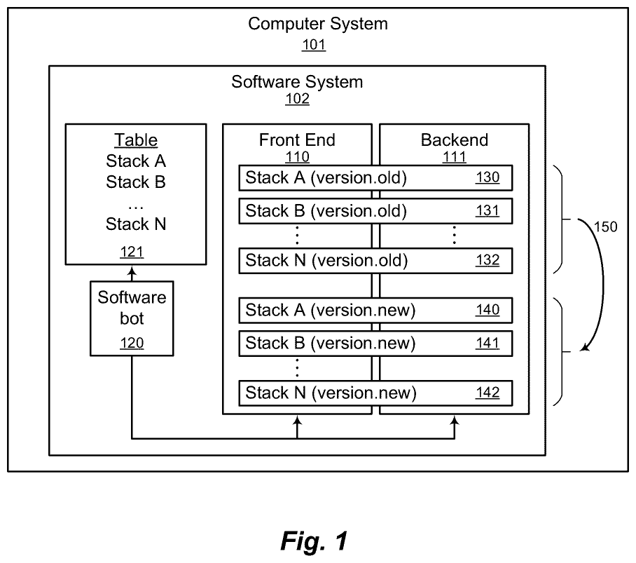

FIG. 1 illustrates a computer system for migrating software according to an embodiment. FIG. 1 shows a computer system 101 comprising a software system 102, which may be an enterprise software system, for example. Computer system 101 may include a plurality of computers, including local desktop or laptop computers for user access and servers connected together over a local or wide area network, such as the Internet, for example. Software system 102 comprises a front end 110 and backend 111. Front end 110 may include software for interfacing with a user, such as software for visualizing data or otherwise presenting data, for example. Users may interface with front end 110 to configure various visualizations, using filters and other visualization software objects such as tables and charts. Composite data visualizations about a topic may be referred to as a story, which is a software stack comprising a plurality of features and functions for creating a plurality of visualizations about one or more topics or related topics, for example. A software stack (aka, story) may comprise data structures, data models, data objects, and rendering libraries for visualizing a story (e.g., software features and functions for implementing data filters and metadata describing filter parameters). Front end 110 may access backend system 111 to retrieve data, metadata, or both. Backend system 111 may include one or more databases, data warehouses, or other data stores for storing data and metadata as well as one or more servers for executing backend software to control storage and retrieval of information (e.g., a database management system or the like). Data and/or metadata stored on backend 111 may be retrieved and filtered using queries to retrieve and send information to front end 110 for presentation to a user. For example, software bot 120 may generate queries for each software stack in the batch to retrieve data and metadata for each software stack in the batch. Because software stacks (e.g., stories) include front end 110 and backend 111 aspects, they are depicted in FIG. 1 on both the front end 110 and backend 111. FIG. 1 illustrates software stacks 130-132 (e.g., software stacks A thru N, where N is an integer).

In various circumstances it may be desirable to migrate one or more software stacks. As mentioned above, it may be desirable to migrate software stacks between sources and targets. Migrating between sources and targets may involve migrating between different versions of a software system or between different instances of software systems (e.g., between a test system and a production system). Accordingly, features and advantages of the present disclosure include configuring a software bot 120 to perform migrations automatically without user intervention. A software bot may invoke functional aspects of an enterprise software system in a particular sequence to perform a migration of a software stack. In some embodiments, a software bot may access a batch of software stacks. Accordingly, migrations between sources and targets may occur for many stories, for example, during lower periods of system usage (e.g., in the evenings or during weekends). Software bots may be configured to execute a plurality of tasks of a process repetitively to migrate a plurality (e.g., a batch) of software stacks between a source and a target. For example, bot 120 may access a table 121 (e.g., a spreadsheet) comprising a plurality of software stacks to be migrated. For each software stack, bot 120 may access front end 110 of software system 102, which is configured to present visual representations of data to a user. Further, bot 120 may access backend 111 of software system 102, which stores data and metadata, for example. Software bot 120 may send data and metadata for the software stacks in table 121 from the backend 111 to the front end 110. Software bot 120 may load the software stacks (e.g., invoke particular stories) on front end 110 configured with the data and metadata from backend 111. Once the software stacks are loaded on the front end, the software by may migrate each of the software stacks from the source to the target as illustrated at 150. Bot 120 may access front end and back end components of a software stack in a source and check all the objects and software structures in the stack for compliance with the target. A source may be a first predefined stack version and a target is a second predefined stack version. A source may be a test system instance of an enterprise software system and a target may be a production system instance of the same enterprise software system, for example. Finally, software bot 120 may write a result for the conversion of each of the software stacks. The result may comprise at least one of an indication of a successful or erroneous conversion. In some embodiments, the results may be written to table 121, where an administrator may review the batches migrated at the end of the process and the results for each software stack (e.g., successful, failed, errors, and error messages). In some embodiments, the software bot may further include recommendations for overcoming errors (if any).

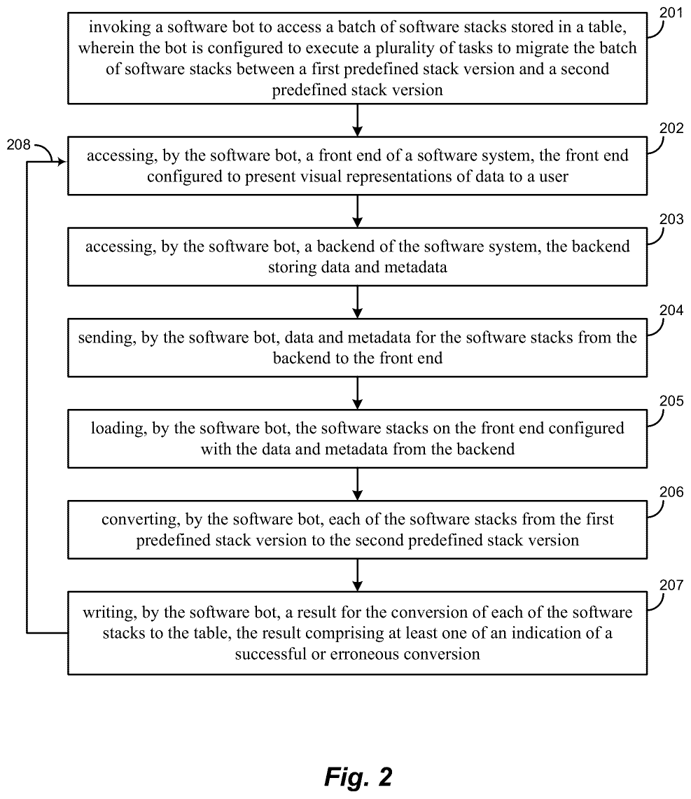

FIG. 2 illustrates a method of migrating software according to an embodiment. At 201, a software bot is invoked to access a batch of software stacks stored in a table. The bot is configured to execute a plurality of tasks to migrate the batch of software stacks between a source and a target. At 202, the software bot accesses a front end of a software system. The front end is configured to present visual representations of data to a user. At 203, the software bot accesses a backend of the software system, where the backend stores data and metadata. At 204, the software bot sends data and metadata for the software stacks from the backend to the front end. At 205, the software bot loads the software stacks on the front end configured with the data and metadata from the backend. At 206, the software bot converts each of the software stacks from the source to the target. At 207, the software bot writes a result for the conversion of each of the software stacks to the table. The result may comprise at least one of an indication of a successful or erroneous conversion, for example. At 208, the software bot iteratively performs steps 202-207 separately for each of the software stacks in the table.

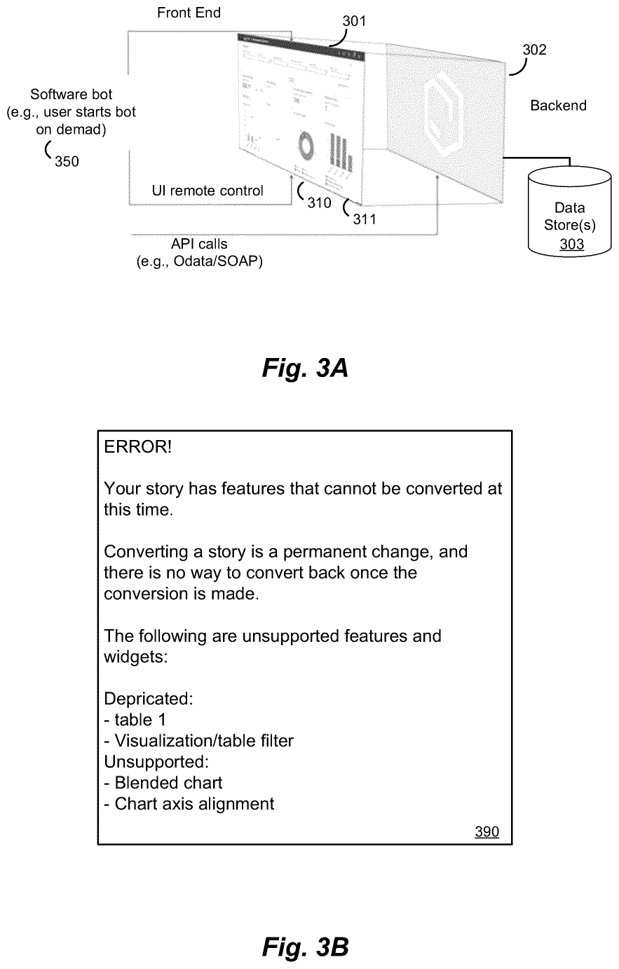

FIG. 3A is an example software system and software bot for migrating software according to an embodiment. Software bot 350 may be invoked (e.g., started) by a user (e.g., a system administrator). Bot 350 accesses front end 301 and backend 302, including data and/or metadata in one or more data store(s) 303. Bot 350 may be configured to automatically invoke user interface (UI) actions to remotely control the UI without user interaction. Bot 350 may access backend 302 using API calls, such as Odata or SOAP. OData (Open Data Protocol) is an ISO/IEC approved, OASIS standard that defines a set of best practices for building and consuming RESTful APIs as is well known to those skilled in the art. SOAP (commonly known as Simple Object Access Protocol) is a messaging protocol specification for exchanging structured information in the implementation of web services in computer networks. SOAP typically uses XML Information Set for its message format, and relies on application layer protocols, most often Hypertext Transfer Protocol (HTTP), although some legacy systems communicate over Simple Mail Transfer Protocol (SMTP), for message negotiation and transmission as is well known to those skilled in the art.

In this example, a software stack comprises a plurality of widgets (e.g., visualization widgets 310 and 311). Widgets may comprise one or more filters and one or more data visualizations (graphs, charts, plots, tables, etc. . . . ). In some embodiments, the bot may automatically determine if each widget is compatible with a target, for example. Determining if each widget is compatible with the target may include determining if a filter associated with a particular widget is compatible with the target, for example. In cases where the software bot determines an incompatibility, front end 301 may generate an error message.

FIG. 3B is an example error message created when migrating software according to an embodiment. For example, when a particular widget for a particular software stack is not compatible with the target, error message 390 may be generated, which may include information about the incompatibility, for example. In response to the error message being detected, software bot 350 may automatically generate an image (e.g., a screen shot) of error message 390, and store the image in a results column of a table (e.g., table 121). In some embodiments, the bot may analyze the image (e.g., using image recognition software) and, based on an analysis of the image, provide recommendations on how to overcome particular errors. Accordingly, a user performing a batch conversion of enterprise system software stacks can review the table and, for each software stack (or story), determine if the migration was successful or not. If not, the image of the error message is stored in the table for a user to review and take appropriate corrective action, for example.

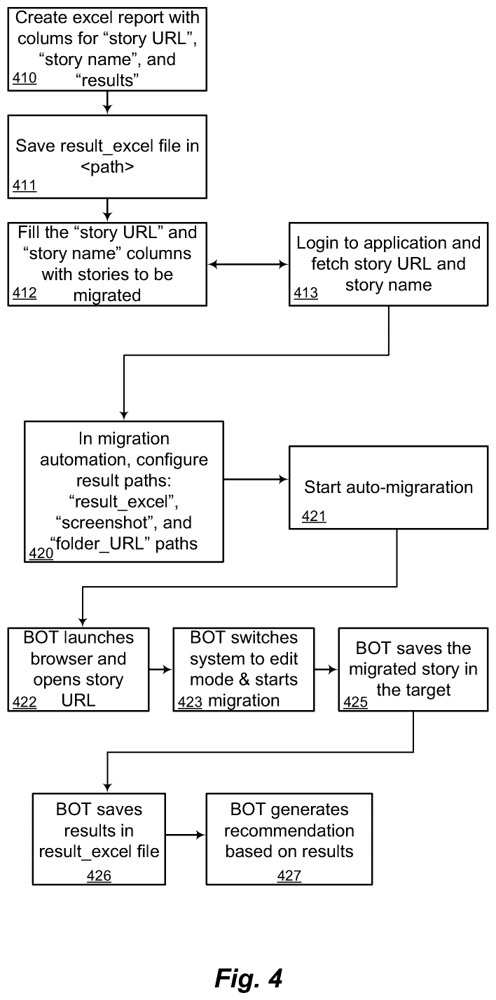

FIG. 4 is an example process for migrating software according to an embodiment. At 410, an excel spreadsheet report (e.g., a table) is created with columns for “story URL” (the URL for the story to migrated), “story name”, and “results.” At 411, the spreadsheet (“result_excel”) file is saved at a known path location (“<path>”). At 412, the “story URL” and “story name” columns are filled with stories (software stacks) to be migrated. At 413, a user may login to an enterprise software application and fetch the story URL and story name to be used in the spreadsheet file, for example. Once the spreadsheet file is filled out with URLs and story names defining the stories to be migrated, the table is ready for processing by a software bot (here, “BOT”).

At 420, result paths are set for migration automation. The result path configurations may include the paths of the result table (result_excel), screenshots, and the folder URL. At 412, auto-migration is started (e.g., by a system administrator). At 422, a BOT launches a browser and opens the first story URL. At 423, the BOT may switch the system front end to edit mode and start the migration process. At 425, the BOT saves the migrated story in the target (e.g., in another version or in another system). At 425, the BOT saves the results in the “result excel” file. At 427, the BOT generates recommendations based on the results.

It is to be understood that steps 410-413 may be performed by one user and steps 420-427 may be performed by another user.

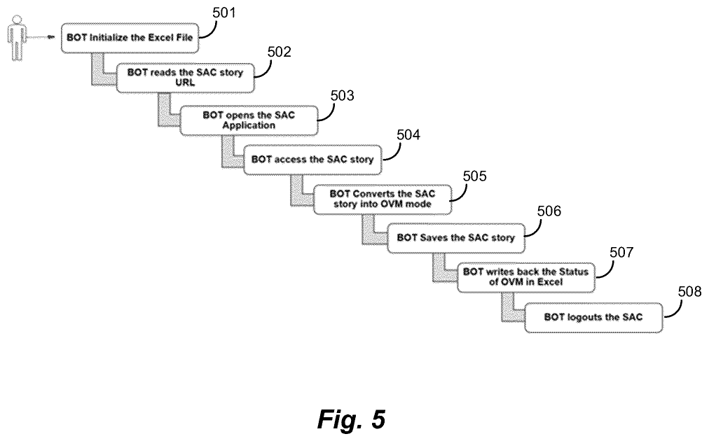

FIG. 5 is another example process for migrating software according to an embodiment.

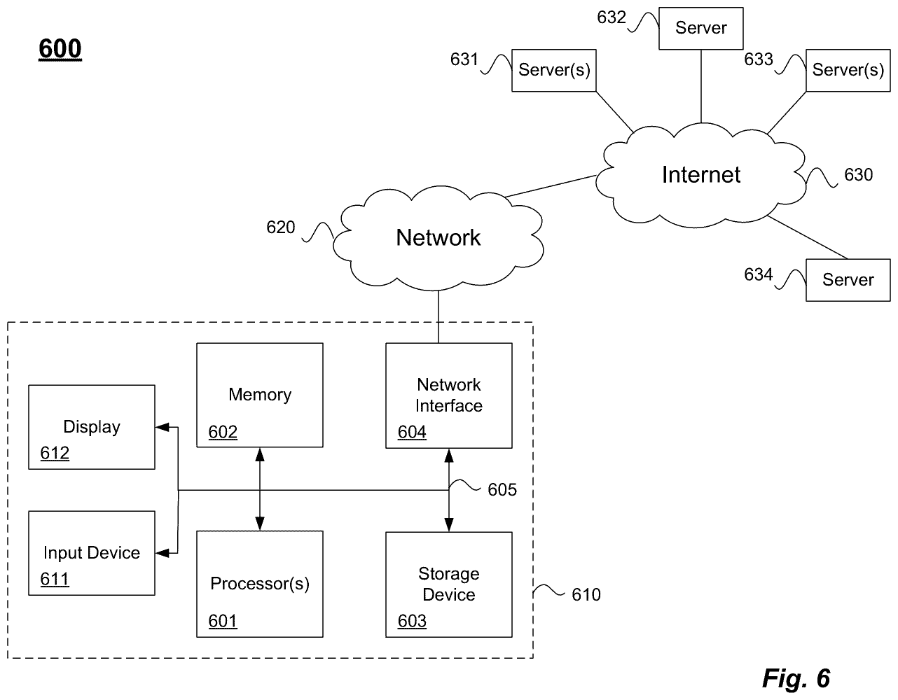

FIG. 6 is an example computer hardware system with an improved software migration system according to an embodiment. In this example, an SAP Analytics Cloud Story (SAC) is converted to an optimized view mode (OMV), which is a particular predefined story version.

At 501, a BOT initializes the excel file.

At 502, the BOT reads the SAC story URL.

At 503, the BOT opens the SAC application.

At 504, the BOT accesses the SAC story.

At 505, the BOT converts the SAC story to OVM mode.

At 506, the BOT saves the SAC story.

At 507, the BOT writes back the status of the OVM in the spreadsheet.

At 509, the BOT logs out of SAC.

FIG. 6 illustrates hardware of a special purpose computing machine configured according to the above disclosure. The following hardware description is merely one example. It is to be understood that a variety of computers topologies may be used to implement the above described techniques. An example computer system 610 is illustrated in FIG. 6. Computer system 610 includes a bus 605 or other communication mechanism for communicating information, and one or more processor(s) 601 coupled with bus 605 for processing information. Computer system 610 also includes memory 602 coupled to bus 605 for storing information and instructions to be executed by processor 601, including information and instructions for performing some of the techniques described above, for example. Memory 602 may also be used for storing programs executed by processor(s) 601. Possible implementations of memory 602 may be, but are not limited to, random access memory (RAM), read only memory (ROM), or both. A storage device 603 is also provided for storing information and instructions. Common forms of storage devices include, for example, a hard drive, a magnetic disk, an optical disk, a CD-ROM, a DVD, solid state disk, a flash or other non-volatile memory, a USB memory card, or any other medium from which a computer can read. Storage device 603 may include source code, binary code, or software files for performing the techniques above, for example. Storage device 603 and memory 602 are both examples of non-transitory computer readable storage mediums.

Computer system 610 may be coupled via bus 605 to a display 612 for displaying information to a computer user. An input device 611 such as a keyboard, touchscreen, and/or mouse is coupled to bus 605 for communicating information and command selections from the user to processor 601. The combination of these components allows the user to communicate with the system. In some systems, bus 605 represents multiple specialized buses for coupling various components of the computer together, for example.

Computer system 610 also includes a network interface 604 coupled with bus 605. Network interface 604 may provide two-way data communication between computer system 610 and a local network 620. Network 620 may represent one or multiple networking technologies, such as Ethernet, local wireless networks (e.g., WiFi), or cellular networks, for example. The network interface 604 may be a wireless or wired connection, for example. Computer system 610 can send and receive information through the network interface 604 across a wired or wireless local area network, an Intranet, or a cellular network to the Internet 630, for example. In some embodiments, a front end (e.g., a browser), for example, may access data and features on backend software systems that may reside on multiple different hardware servers on-prem 631 or across the Internet 630 on servers 632-635. One or more of servers 632-635 may also reside in a cloud computing environment, for example.

### Further Examples

Each of the following non-limiting features in the following examples may stand on its own or may be combined in various permutations or combinations with one or more of the other features in the examples below. In various embodiments, the present disclosure may be implemented as a processor or method.

Embodiments of the present disclosure include techniques for automating software migrations.

In one embodiment, the present disclosure includes a method of migrating software comprising: invoking a software bot to access a batch of software stacks stored in a table, wherein the software bot is configured to execute a plurality of tasks to migrate the batch of software stacks between a source and a target; (i) accessing, by the software bot, a front end of a software system, the front end configured to present visual representations of data to a user; (ii) accessing, by the software bot, a backend of the software system, the backend storing data and metadata; (iii) sending, by the software bot, data and metadata for the software stacks from the backend to the front end; (iv) loading, by the software bot, the software stacks on the front end configured with the data and metadata from the backend; (v) migrating, by the software bot, each of the software stacks from the source to the target; and (vi) writing, by the software bot, a result for the conversion of each of the software stacks to the table, the result comprising at least one of an indication of a successful or erroneous conversion.

In another embodiment, the present disclosure includes a system for migrating software comprising: at least one processor; at least one non-transitory computer readable medium storing computer executable instructions that when executed by the at least one processor cause the system to perform actions comprising: invoking a software bot to access a batch of software stacks stored in a table, wherein the software bot is configured to execute a plurality of tasks to migrate the batch of software stacks between a source and a target; accessing, by the software bot, a front end of a software system, the front end configured to present visual representations of data to a user; accessing, by the software bot, a backend of the software system, the backend storing data and metadata; sending, by the software bot, data and metadata for the software stacks from the backend to the front end; loading, by the software bot, the software stacks on the front end configured with the data and metadata from the backend; converting, by the software bot, each of the software stacks from the source to the target; and writing, by the software bot, a result for the conversion of each of the software stacks to the table, the result comprising at least one of an indication of a successful or erroneous conversion.

In another embodiment, the present disclosure includes one or more non-transitory computer-readable media storing computer-executable instructions that, when executed by a processor, perform a method of migrating software, the method comprising: invoking a software bot to access a batch of software stacks stored in a table, wherein the software bot is configured to execute a plurality of tasks to migrate the batch of software stacks between a source and a target; accessing, by the software bot, a front end of a software system, the front end configured to present visual representations of data to a user; accessing, by the software bot, a backend of the software system, the backend storing data and metadata; sending, by the software bot, data and metadata for the software stacks from the backend to the front end; loading, by the software bot, the software stacks on the front end configured with the data and metadata from the backend; converting, by the software bot, each of the software stacks from the source to the target; and writing, by the software bot, a result for the conversion of each of the software stacks to the table, the result comprising at least one of an indication of a successful or erroneous conversion.

In one embodiment, the software bot iteratively performs steps (i) to (vi) separately for each of the software stacks in the table.

In one embodiment, each software stack comprises a plurality of widgets, the method further comprising determining if each widget is compatible with the target.

In one embodiment, the widgets comprise one or more filters and one or more data visualizations.

In one embodiment, determining if each widget is compatible with the target comprises determining if a filter associated with a particular widget is compatible with the target.

In one embodiment, when a particular widget for a particular software stack is not compatible with the target, the method further comprising: generating an error message information about the incompatibility; generating, by the software bot, an image of the error message; and storing, by the software bot, the image in a results column of the table.

In one embodiment, the software bot generates queries for each software stack in the batch to retrieve corresponding data and metadata.

In one embodiment, the software stacks comprise data structures, data models, data objects, and rendering libraries.

In one embodiment, the source comprises a first predefined stack version and the target is a second predefined stack version.

In one embodiment, the source comprises a test system and the target is a production system.

The above description illustrates various embodiments along with examples of how aspects of some embodiments may be implemented. The above examples and embodiments should not be deemed to be the only embodiments, and are presented to illustrate the flexibility and advantages of some embodiments as defined by the following claims. Based on the above disclosure and the following claims, other arrangements, embodiments, implementations and equivalents may be employed without departing from the scope hereof as defined by the claims.

What is claimed is:

1. A method of migrating software comprising:
invoking a software bot to access a batch of software stacks stored in a table, wherein the software bot is configured to execute a plurality of tasks to migrate the batch of software stacks between a source and a target;
(i) accessing, by the software bot, a front end of a software system, the front end configured to present visual representations of data to a user;
(ii) accessing, by the software bot, a backend of the software system, the backend storing data and metadata;
(iii) sending, by the software bot, data and metadata for the software stacks from the backend to the front end;
(iv) loading, by the software bot, the software stacks on the front end configured with the data and metadata from the backend;
(v) migrating, by the software bot, each of the software stacks from the source to the target; and
(vi) writing, by the software bot, a result for the conversion of each of the software stacks to the table, the result comprising at least one of an indication of a successful or erroneous conversion.

2. The method of claim 1, wherein the software bot iteratively performs steps (i) to (vi) separately for each of the software stacks in the table.

3. The method of claim 1, wherein each software stack comprises a plurality of widgets, the method further comprising determining if each widget is compatible with the target.

4. The method of claim 3, wherein the widgets comprise one or more filters and one or more data visualizations.

5. The method of claim 3, wherein determining if each widget is compatible with the target comprises determining if a filter associated with a particular widget is compatible with the target.

6. The method of claim 3, wherein, when a particular widget for a particular software stack is not compatible with the target, the method further comprising:
generating an error message information about the incompatibility;
generating, by the software bot, an image of the error message; and
storing, by the software bot, the image in a results column of the table.

7. The method of claim 1, wherein the software bot generates queries for each software stack in the batch to retrieve corresponding data and metadata.

8. The method of claim 1, wherein the software stacks comprise data structures, data models, data objects, and rendering libraries.

9. The method of claim 1, wherein the source comprises a first predefined stack version and the target is a second predefined stack version.

10. The method of claim 1, wherein the source comprises a test system and the target is a production system.

11. A system for migrating software comprising:
at least one processor;
at least one non-transitory computer readable medium storing computer executable instructions that when executed by the at least one processor cause the system to perform actions comprising:
invoking a software bot to access a batch of software stacks stored in a table, wherein the software bot is configured to execute a plurality of tasks to migrate the batch of software stacks between a source and a target;
accessing, by the software bot, a front end of a software system, the front end configured to present visual representations of data to a user;
accessing, by the software bot, a backend of the software system, the backend storing data and metadata;
sending, by the software bot, data and metadata for the software stacks from the backend to the front end;
loading, by the software bot, the software stacks on the front end configured with the data and metadata from the backend;
converting, by the software bot, each of the software stacks from the source to the target; and
writing, by the software bot, a result for the conversion of each of the software stacks to the table, the result comprising at least one of an indication of a successful or erroneous conversion.

12. The system of claim 11, wherein each software stack comprises a plurality of widgets, the widgets comprising one or more filters and one or more data visualizations, the method further comprising determining if each widget is compatible with the target.

13. The system of claim 12, wherein determining if each widget is compatible with the target comprises determining if a filter associated with a particular widget is compatible with the target.

14. The system of claim 12, wherein, when a particular widget for a particular software stack is not compatible with the target, the method further comprising:
generating an error message;
generating, by the software bot, an image of the error message; and
storing, by the software bot, the image in a results column of the table.

15. The system of claim 11, wherein the software bot generates queries for each software stack in the batch to retrieve data and metadata for each software stack in the batch.

16. The system of claim 11, wherein the software stacks comprise data structures, data models, data objects, and rendering libraries.

17. One or more non-transitory computer-readable media storing computer-executable instructions that, when executed by a processor, perform a method of migrating software, the method comprising:
invoking a software bot to access a batch of software stacks stored in a table, wherein the software bot is configured to execute a plurality of tasks to migrate the batch of software stacks between a source and a target;
accessing, by the software bot, a front end of a software system, the front end configured to present visual representations of data to a user;
accessing, by the software bot, a backend of the software system, the backend storing data and metadata;
sending, by the software bot, data and metadata for the software stacks from the backend to the front end;
loading, by the software bot, the software stacks on the front end configured with the data and metadata from the backend;
converting, by the software bot, each of the software stacks from the source to the target; and
writing, by the software bot, a result for the conversion of each of the software stacks to the table, the result comprising at least one of an indication of a successful or erroneous conversion.

18. The non-transitory computer-readable media of claim 17, wherein each software stack comprises a plurality of widgets, the method further comprising determining if each widget is compatible with the target.

19. The non-transitory computer-readable media of claim 18, wherein determining if each widget is compatible with the target comprises determining if a filter associated with a particular widget is compatible with the target.

20. The non-transitory computer-readable media of claim 18, wherein, when a particular widget for a particular software stack is not compatible with the target, the method further comprising:
generating an error message;
generating, by the software bot, an image of the error message; and
storing, by the software bot, the image in a results column of the table.
